(19) United States
(12) Patent Application Publication
(10) Pub. No.: US 2014/0272162 A1
(43) Pub. Date: Sep. 18, 2014

(54) POLYASPARTIC GEL COATS WITH IMPROVED WEATHER AND CHLORINE RESISTANCE

(71) Applicant: Bayer MaterialScience LLC, Pittsburgh, PA (US)

(72) Inventor: Ahren Olson, Aliquippa, PA (US)

(73) Assignee: Bayer MaterialScience LLC, Pittsburgh, PA (US)

(21) Appl. No.: 14/208,296

(22) Filed: Mar. 13, 2014

Related U.S. Application Data
(60) Provisional application No. 61/779,163, filed on Mar. 13, 2013.

(51) Int. Cl. C09D 175/06; B05D 1/02

(52) U.S. Cl. CPC C09D 175/06; B05D 1/02
USPC 427/427.4; 560/118; 524/873

(57) ABSTRACT

The present invention provides a two-component coating composition comprising as component I (a) an acrylate modified amine functional polyaspartic acid ester having an acrylate/acid ester mixture of greater than 2 to 30 wt. % acrylate; (b) at least one moisture scavenger; (c) at least one deaerator; (d) at least one plasticizer; and optionally (e) a short chain polyol having a hydroxyl value of >100; and as component II one or more aliphatic polyisocyanates. Methods of preparing the coating composition, methods of coating a substrate, and coated substrates are also provided. The coating is particularly suitable as a gel coat.

### BACKGROUND OF THE INVENTION

This invention pertains generally to coating compositions prepared from acrylate-modified aspartates and polyisocyanates. The coatings are particularly suitable as gel coats on fiber-reinforced composites.

Glass fiber reinforced plastics (FRP) include glass fiber marine craft, showers and bathtubs, building and automotive panels, swimming pools, satellite dishes, sporting equipment, and the like. Conventional FRP construction methods include the construction of a mold, the application of a releasing agent such as a wax to the mold, the application of a gel coat to the waxed mold, and the application of a glass fiber reinforced laminate to the gel coat. The unsaturated polyester resin contained in the gel coat and the ensuing laminating resin which binds the-glass fiber reinforcement is a styrene or styrene/methyl methacrylate, free radical initiated, liquid thermosetting resin which upon catalysis with an organic peroxide such as methyl ethyl ketone peroxide, gels and cures to a solid thermosetting state.

When the FRP is removed from the mold, the glass fiber reinforced laminate is covered by a decorative layer of gel coat. Gel coats can provide surfaces with high initial and extended gloss for long-lasting visual appeal or otherwise provide a high quality finish on the visible surface of a product. Gel coats can also be used to present desired color characteristics or other visual effects such as fluorescent, pearlescent, iridescent, metallic reflective, non-reflective, and/or retro-reflective effects, or the like. Unfortunately, prolonged exposure to environmental conditions affects the gel coat in several detrimental ways. For example, a gel coat exposed to sunlight and other elements will lose its gloss in a relatively short period of time. In the FRP industry this loss of gloss is known as chalking.

Two-component coating compositions having a polyisocyanate component and an isocyanate-reactive component (a polyhydroxyl component) are known and have been used for the preparation of high quality gel coatings. These compositions can be rendered rigid, elastic, resistant to abrasion and to solvents and, above, all, resistant to weathering. Polyaspartic esters have been used as isocyanate-reactive components in such two-component (2K) compositions. Gel coat compositions comprising polyaspartic esters are known in the industry and have found favor due to their low VOC. Reducing solvent emissions to a minimum has been an ongoing objective in the development of environmentally friendly coating systems. The low viscosity properties of polyaspartic binders—some down to below 100 mPas—make it possible to formulate “very high solids” coatings which can be applied easily with the equipment regularly used in corrosion protection and industrial coating areas. Coating compositions based upon polyisocyanates and polyaspartic ester resins have been described in U.S. Pat. Nos. 5,126,170; 5,236,741; 5,397,930; 5,489,704; 5,561,214; 5,623,045; 6,355,829; and 8,178,204.

While gel coats utilizing polyaspartic acid esters have shown great chemical and environmental exposure profiles, improved gel coat formulations are now discovered that will further protect the coating from the elements.

### SUMMARY OF THE INVENTION

According to its major aspects, and briefly stated, the present invention includes a coating composition comprising:

Component I: which is an acrylate modified amine functional polyaspartic acid ester having an acrylate/acid ester mixture of from 2 to 30 wt. % acrylate; and

Component II: which may be one or more aliphatic polyisocyanates.

In certain embodiments of the present invention, Component I of the coating composition may further comprise a low molecular weight short chain polyol having a hydroxyl value of >100.

The acrylate modified amine functional polyaspartic acid ester may comprise the reaction product of one or more (cyclo)aliphatic diamines, one or more diacrylate compounds and one or more maleic and/or fumaric acid esters.

The present invention is also directed to a polyaspartic acid ester comprising:
i) an acrylate modified polyaspartic acid ester consisting essentially of the reaction product of one or more (cyclo)aliphatic diamines, one or more diacrylates and one or more maleic and/or fumaric acid esters; and
ii) a polyaspartic acid ester consisting essentially of the reaction product of one or more diamines and one or more maleic and/or fumaric acid esters.

The present invention is also directed to methods of preparing the coating composition, methods of coating a substrate, and coated substrates.

### BRIEF DESCRIPTION OF THE DRAWINGS

Aspects, features, benefits and advantages of the embodiments herein will be apparent with regard to the following description, appended claims, and accompanying drawings.

FIG. 1 illustrates experimental exposure profiles for coating compositions according to embodiments of the present invention determined by ASTM D6695 “Standard Practice for Xenon-Arc Exposures of Paint and Related Coatings”; and

FIG. 2 illustrates experimental exposure profiles for coating compositions according to embodiments of the present invention determined by a modification of ASTM D6695 to add a chlorine emersion cycle (7 days of ASTM D6695 cycle 5 followed by 24 hours of immersion in 10 ppm chlorinated water).

### DETAILED DESCRIPTION OF THE PREFERRED EMBODIMENTS

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances:

In the following description, the present invention is set forth in the context of various alternative embodiments and implementations involving coatings prepared from amine functional polyaspartic acid esters, polyisocyanates, and optionally polyols.

Polyaspartic esters have been previously used as isocyanate-reactive components in 2K gel coat compositions. Acrylate modified polyaspartic acid esters have previously been prepared (See U.S. Pat. No. 8,178,204) and used in such 2K gel coat compositions. Acrylate modification was not used at levels greater than 2 wt. % acrylate to acid ester mixture, however, because of very fast curing times. The present inventors have discovered methods to use the increased functionality provided by up to 30% acrylate modification of the polyaspartic acid ester in 2K gel coat compositions which show greatly improved environmental resistance profiles and manageable cure times.

Surprisingly, acrylate modification of the polyaspartic acid ester to provide an average functionality of greater than 2 improves the gel coat's resistance to UV light exposure by as much as 40-fold. Gels coats comprising 5 wt. % and 10 wt. % acrylate:acid ester mixtures showed a gloss retention of greater than 80% after 5000 hours of ASTM D6695 Xenon Arc exposure, while the <2% acrylate:acid ester mixture of the prior art showed less than 5% gloss retention under the same exposure conditions. Further, chlorine exposure profiles were greatly improved for gel coats comprising 5 wt. % and 10 wt. % acrylate:acid ester mixtures, showing greater than 85% gloss retention after more than 2500 hours of cyclic UV and chlorine exposure as compared to only 20% gloss retention for the <2% acrylate:acid ester mixture of the prior art.

The amine functional polyaspartic acid esters of the present invention may comprise an acrylate modified aspartate which is the reaction product of one or more primary (cyclo)aliphatic diamines, one or more diacrylates and one or more maleic and/or fumaric acid esters. The diamine, diacrylate and ester may be reacted together in an equivalent ratio of amine to amine-reactive components of 0.8/1.0 to 1.2/1.0, preferably 0.95/1.0 to 1.05/1.0, most preferably 1.0/1.0. When the most preferred ratio of amine to amine-reactive components is used, the diamine, acrylate and ester may be reacted together in a ratio of from 1 equivalent amine:0.02 equivalents acrylate:0.98 equivalents maleate, to 1 equivalent amine:0.3 equivalents acrylate:0.7 equivalents maleate.

In the acrylate/acid ester mixture, about 2-30 wt. % may be diacrylate, the remainder being acid ester, more preferably 5-10 wt. % may be diacrylate, the remainder being acid ester.

The amine functional polyaspartic acid esters of the present invention may be a blend of an acrylate modified polyaspartic acid ester mixed with other polyaspartic acid esters to achieve the desired level of acrylate/acid ester. For example, an acrylate modified aspartate having about 20 wt. % diacrylate may be mixed in a 1:1 ratio with a non-acrylate modified aspartate to achieve a final acrylate/acid ester mixture having about 10 wt. % acrylate, the remainder acid ester.

Thus, in certain embodiments of the present invention, the amine functional polyaspartic acid esters may further comprise a non-acrylate modified aspartate which is the reaction product of one or more primary (cyclo)aliphatic diamines, and one or more maleic and/or fumaric acid esters. The diamine and acid ester may be reacted together in an equivalent ratio of amine to amine-reactive components of 0.8/1.0 to 1.2/1.0, preferably 0.95/1.0 to 1.05/1.0, most preferably 1.0/1.0.

Diamines suitable for making the amine functional polyaspartic acid esters of the present invention include, without limitation, ethylenediamine, 1,2-diaminopropane, 1,4-diaminobutane, 1,3-diaminobenzene, 1,6-diaminohexane, 2-methyl-1,5-pentane diamine, 2,5-diamino-2,5-dimethylhexane, 2,2,4- and/or 2,4,4-trimethyl-1,6-diamino-hexane, 1,11-diaminoundecane, 1,12-diaminododecane, 1,3- and/or 1,4-cyclohexane diamine, 1-amino-3,3,5-trimethyl-5-aminomethyl-cyclohexane, 2,4- and/or 2,6-hexahydrotoluoylene diamine, 2,4′- and/or 4,4′-diamino-dicyclohexyl methane and 3,3′-dialkyl-4,4′-diamino-dicyclohexyl methanes (such as 3,3′-dimethyl-4,4′-diamino-dicyclohexyl methane and 3,3′-diethyl-4,4′-diamino-dicyclohexyl methane), 2,4- and/or 2,6-diaminotoluene and 2,4′- and/or 4,4′-diaminodiphenyl methane, or mixtures thereof.

Other suitable diamines include, for example, 1,3,3-trimethyl-1-aminomethyl-5-aminocyclohexane (IPDA), 1,8-p-diaminomenthane, bis(4-aminocyclohexyl)methane, bis(4-amino-3-methylcyclohexyl)methane, bis(4-amino-3,5-dimethylcyclohexyl)methane, bis(4-amino-2,3,5-trimethylcyclohexyl)methane, 1,1-bis(4-aminocyclohexyl)propane, 2,2-(bis(4-aminocyclohexyl)propane, 1,1-bis(4-aminocyclohexyl)ethane, 1,1-bis(4-aminocyclohexyl)butane, 2,2-bis(4-aminocyclohexyl)butane, 1,1-bis(4-amino-3-methylcyclohexyl)ethane, 2,2-bis(4-amino-3-methylcyclohexyl)propane, 1,1-bis(4-amino-3,5-dimethyl-cyclohexyl)ethane, 2,2-bis(4-amino-3,5-dimethylcyclohexyl)propane, 2,2-bis(4-amino-3,5-dimethylcyclo-hexyl)butane, 2,4-diamino-dicyclohexylmethane, 4-aminocyclohexyl-4-amino-3-methyl-cyclohexylmethane, 4-amino-3,5-dimethylcyclohexyl-4-amino-3-methylcyclohexylmethane, and 2-(4-aminocyclohexyl)-2-(4-amino-3-methylcyclohexyl)methane.

Preferred are 1,4-diaminobutane, 2-methyl-1,5-pentane diamine, 1,6-diaminohexane, 2,2,4- and/or 2,4,4-trimethyl-1,6-diaminohexane, 1-amino-3,3,5-trimethyl-5-aminomethylcyclohexane, 4,4′-diamino-dicyclohexylmethane or 3,3′-dimethyl-4,4′-diamino-dicyclohexyl-methane. Most preferred is 4,4′-diamino-dicyclohexyl methane.

Maleic or fumaric acid esters suitable for making the amine functional polyaspartic acid esters of the present invention are compounds of the formula

R¹OOC—CR³═CR⁴—COOR²

where R¹, R², R³ and R⁴ are groups that are “inert to isocyanate groups under the reaction conditions,” which means that these groups do not have Zerevitinov-active hydrogens (CH-acid compounds; cf. Römpp Chemie Lexikon, Georg Thieme Verlag Stuttgart), such as OH, NH or SH, R¹ and R², independently of one another, are preferably C₁ to C₁₀ alkyl residues, more preferably methyl or ethyl residues. R³ and R⁴ are preferably hydrogen. Examples of suitable maleic or fumaric acid esters are dimethyl maleate, diethyl maleate, dibutyl maleate and the corresponding fumarates.

Diacrylate-containing compounds suitable for making the amine functional polyaspartic acid esters of the present invention include, without limitation, ethylene glycol diacrylate, propane 1,3-dial diacrylate, butane 1,4-dial diacrylate, hexane 1,6-diol diacrylate, and the corresponding methacrylates. Also suitable are di(meth)acrylates of polyether glycols initiated with ethylene glycol, propane 1,3-diol, butane 1,4-diol.

Acrylate modified aspartates may be prepared by reacting, in a first step, a primary (cyclo)aliphatic diamine with a diacrylate-containing compound to form a first reaction product. In a second step, the first reaction product is reacted with a maleic and/or fumaric acid ester. Both first and second steps are preferably carried out in the absence of any catalyst. The reaction is carried out at atmospheric pressure, under a nitrogen blanket, at a temperature of about 50°-55° C., with exotherm controlled by the rate of addition, so that the temperature is kept in this range. Typically, preparation is carried out over a period of 12-24 hours, under monitoring, and the reaction stopped when the desired unsaturation level is obtained.

The non-acrylate modified aspartates may be prepared by methods known in the art from the above-mentioned starting materials. Reaction preferably takes place within the temperature range of 0 to 100° C. The starting materials are used in amounts such that there is at least one, preferably one, olefinic double bond for each primary amino group. Any starting materials used in excess can be separated off by distillation following the reaction. The reaction can take place in the presence or absence of suitable solvents, such as methanol, ethanol, propanol, dioxane or mixtures thereof. A particularly preferred amino-functional polyaspartate is Desmophen® NH 1420, available from Bayer MaterialScience LLC of Pittsburgh, Pa.

Coating compositions of the present invention may further comprise at least one moisture scavenger or drying agent. As used herein, the term “moisture scavenger” refers to compounds that eliminate free moisture (water). Moisture scavengers are well known in the art. Suitable moisture scavengers include, for example, ethylenically unsaturated alkoxysilanes, such as vinyl trimethoxysilane, vinyl triethoxysilane, and the like. A preferred moisture scavenger is vinyl trimethoxy silane sold under the trade name Silquest A-171®, available from Crompton Corp. of Middlebury, Conn. Mixtures of moisture scavengers can also be used.

Coating compositions of the present invention may further include at least one deaerator or defoamer. As used herein, the term “deaerator” refers to compounds that are suitable for removing dissolved gases and breaking up bubbles and foam that may arise during mixing, and which are undesirable in the final coating. Defoamers/deaerators are well known in the art. In the context of the present invention, preferred deaerators include silicone-based compounds, emulsions, and mixtures, such as polysiloxanes, polysiloxanes mixed with hydrophobic solids, siloxated polyethers mixed with hydrophobic particles, and emulsions of siloxated polyethers. Particularly preferred is a polysiloxane sold under the trade name TEGO® Airex 944, available from Tego Chemie Service GmbH of Germany. Also suitable are BYK®-25, BYK®-28, and BYK®-A 530 silicone defoamers sold by BYK-Chemie GmbH of Germany.

Coating compositions of the present invention may further include at least one plasticizer. The term “plasticizer” is given the meaning ordinarily used in the art, an organic compound added to a polymer to facilitate processing and to increase the flexibility and toughness of the final product by internal modification of the polymer molecule. Numerous types of plasticizers are known in the art, and use will depend on the desired properties in the final product. In the context of the present invention, preferred plasticizers are aromatic sulfonic acid esters. Particularly preferred is an arylsulfonic acid ester of phenol sold under the trade name Mesamoll® by Bayer Material Science LLC of Pittsburgh, Pa.

In certain embodiments of the present invention, the coating composition may further comprise a low molecular weight short chain polyol. The polyols suitable in the coating compositions of the present invention can be and in general will have average hydroxyl values as determined by ASTM designation E-222-67, Method B, between about 10 and 1000, and preferably between about 20 and 200. The term “polyol” is meant to include materials having an average of two or more primary hydroxyl groups per molecule.

The polyols include low molecular weight (short chain) dials, triols and higher alcohols and polymeric polyols such as polyester polyols, polyether polyols polyurethane polyols and hydroxy-containing (meth)acrylic polymers.

The low molecular weight dials, triols and higher alcohols suitable as polyols in the present invention are known in the art. For the most part, they are monomeric and have hydroxy values of 200 and above, usually within the range of 200 to 1500. Such materials include aliphatic polyols, particularly alkylene polyols containing from 2 to 18 carbon atoms. Examples include ethylene glycol, 1,4-butanediol, 1,6-hexanediol; cycloaliphatic polyols such as cyclohexane dimethanol. Examples of triols and higher alcohols include trimethylol propane and pentaerythritol. Also useful are polyols containing ether linkages such as diethylene glycol and triethylene glycol.

The most suitable polymeric polyols are those having hydroxyl values less than 200, such as 10 to 180. Examples of polymeric polyols include polyalkylene ether polyols, polyester polyols including hydroxyl-containing polycaprolactones, hydroxy-containing (meth)acrylic polymers, polycarbonate polyols and polyurethane polymers.

Polyester polyols suitable in the practice of the present invention can be prepared by the polyesterification of organic polycarboxylic acids or anhydrides thereof with organic polyols. Usually, the polycarboxylic acids and polyols are aliphatic or aromatic dibasic acids and diols. The diols which are usually employed in making the polyester include alkylene glycols, such as ethylene glycol and butylene glycol, neopentyl glycol and other glycols such as cyclohexane dimethanol, caprolactone diol (for example, the reaction product of caprolactone and ethylene glycol), polyether glycols, for example, poly(oxytetramethylene)glycol and the like. However, other dials of various types and, as indicated, polyols of higher functionality can also be utilized.

The acid component of the polyester consists primarily of monomeric carboxylic acids or anhydrides having 2 to 18 carbon atoms per molecule. Among the acids which are useful are phthalic acid, isophthalic acid, terephthalic acid, tetrahydrophthalic acid, hexahydrophthalic acid, adipic acid, azelaic acid, sebacic acid, maleic acid, glutaric acid, chlorendic acid, tetrachlorophthalic acid and other dicarboxylic acids of varying types. Also, there may be employed higher polycarboxylic acids such as trimellitic acid and tricarballylic acid (where acids are referred to above, it is understood that the anhydrides of those acids which form anhydrides can be used in place of the acid). Also, lower alkyl esters of acids such as dimethyl glutamate can be used.

Besides polyester polyols formed from polybasic acids and polyols, polycaprolactone-type polyesters can also be employed. These products are formed from the reaction of a cyclic lactone such as epsilon-caprolactone with a polyol with primary hydroxyls such as those mentioned above.

A particularly preferred is polyol is the branched polyester polyol Desmophen® XP 2488, available from Bayer MaterialScience LLC of Pittsburgh, Pa.

Coating compositions of the present invention further comprise one or more aliphatic polyisocyanates. Non-limiting examples of suitable aliphatic polyisocyanates include monomeric aliphatic, cycloaliphatic and/or araliphatic diisocyanates. Examples of diisocyanates include 1,6-diisocyanatohexane, 1-isocyanato-3,3,5-tri-methyl-5-isocyanatomethylcyclohexane (isophorone diisocyanate), 4,4-diisocyanatodicyclohexylmethane, 1,4-diisocyanatocyclohexane, 1-methyl-2,4-diisocyanatocyclohexane, 1-methyl-2,6-diisocyanatocyclohexane and mixtures thereof. 4-isocyanatomethyl-1,8-octane diisocyanate will be used without further modification.

The polyisocyanates of the aforementioned kind preferably have an NCO group content of 5 to 25% by weight, an average NCO functionality of 2.0 to 5.0, preferably 2.8 to 4.0, and a residual amount of monomeric diisocyanates, used for their preparation, of below 1% by weight, preferably below 0.5% by weight.

Polyisocyanates containing urethane groups can be used, for example, the reaction products of 2,4- and optionally 2,6-diisocyanatotoluene or 1-methyl-2,4- and optionally 1-methyl-2,6-diisocyanatocyclohexane with substoichiometric amounts of trimethylolpropane or its mixtures with simple diols, such as the isomeric propanediols or butanediols. The preparation of polyisocyanates of this kind containing urethane groups, in virtually monomer-free form, is described in, for example, DE-A 109 01 96.

Suitable isocyanates can also include oligomeric polyisocyanates including, but not limited to, dimers, such as the uretdione of 1,6-hexamethylene diisocyanate, trimers, such as the biuret and isocyanurate of 1,6-hexanediisocyanate and the isocyanurate of isophorone diisocyanate, and polymeric oligomers. Modified polyisocyanates can also be used, including, but not limited to, carbodiimides and uretdiones, and mixtures thereof. Examples of preferred polyisocyanates are those containing biuret, isocyanurate and/or iminooxadiazinedione structures. Polyisocyanates containing iminooxadiazinedione groups, and their preparation, can be found in, for example, EP-A 798 299, EP-A 896 009, EP-A 962 454 and EP-A 962 455. Particularly preferred are the aliphatic, aliphatic/cycloaliphatic and/or cycloaliphatic single-type or mixed trimers based on 1,6-diisocyanatohexane and/or isophorone diisocyanate, which are obtainable in accordance, for example, with U.S. Pat. No. 4,324,879, U.S. Pat. No. 4,288,586, DE-A 310 026 2, DE-A 310 026 3, DE-A 303 386 0 or DE-A 314 467 2, some of which are available under the designation DESMODUR® from Bayer MaterialScience LLC of Pittsburgh, Pa. including DESMODUR® N 100, DESMODUR® N 3200, DESMODUR® N 3300, DESMODUR® N 3400, DESMODUR® N 3900, DESMODUR® XP 2410, DESMODUR® XP 2580 and DESMODUR® XP 2795.

Certain embodiments of the coating compositions of the present invention will comprise 35-65 wt. % amine functional polyaspartic acid ester, 25-35 wt. % polyisocvanate, 0.5-4.0 wt. % plasticizer, 0.25-3.0 wt. % moisture scavenger and 0.25-3.0 wt. % defoamer, based on the total weight of the composition (Components I and II).

The coating compositions of the present invention preferably have an NCO:NH ratio from the polyaspartic acid ester and polyisocyanate of from 0.9 NCO:1 NH to 1.5 NCO:1 NH, preferably 0.9 NCO:1 NH to 1.2 NCO:1 NH, most preferably 1 NCO:1 NH to 1.1 NCO:1 NH.

Coating compositions of the present invention can optionally include additional additives, as are known in the art, non-limiting examples of which are thixatropes (thickeners), catalysts, fillers, emulsifiers, surface-active stabilizers, pigments, dyes. UV-stabilizers, hindered-amine light stabilizers, antioxidants, leveling additives, dispersing and grinding aids, impact modifiers, flame-retardants, biocides, and the like.

In use, Component I (the amine functional polyaspartic acid esters) and optional additives, having been premixed with a Cowels® type mixing blade or similar equipment, and Component II (the polyisocyanates) are combined in a manner suitable to facilitate mixing and reaction thereof, and to enable coating of the mixed compositions onto the desired substrate prior to completion of the reaction.

Several types of spray systems are known for applying 2K coating compositions. If the two components are not highly reactive, it is possible to mix the two components prior to use and apply the systems with known one-component, airless or air-assisted spray systems. These systems are generally used with coating compositions having a pot life of one hour to several hours.

The 2K compositions of the present invention may be highly reactive, and may be applied with 2K spray systems which may be either high pressure (more than 1500 psi) or low pressure (less than 1500 psi) systems. In these systems the two components are generally introduced under high or low pressure into a static mixer and are then passed through a spray tip under sufficient pressure to atomize the liquid. The mixing chamber is generally purged with a purge rod or pressurized air.

Preferably, these compositions are mixed together using a plural component positive displacement mixing spray system, wherein the spray combines streams of the compositions with complete mixing and simultaneous application of the mixed spray to the intended substrate. The system will include the following components: a proportioning section which meters the components and pressurizes the material; optionally, a heating section to raise the temperatures of the components to adjust the viscosity; and an impingement spray gun which combines the two components and allows mixing just prior to atomization. Alternatively, the spray system will comprise a short static mixing element at the end of the spray nozzle to assist in accomplishing complete mixing. An example of a suitable spray is the low pressure plural component positive displacement equipment made by Langeman Manufacturing Ltd. of Learnington, Ontario, Canada. Alternatively, the coating of the present invention may be prepared by mixing in a static mix device to achieve blending of the compositions. However, at the spray gun, the components are combined and pumped through a length of tubing which contains elements designed to mix the components prior to atomizing. The static system requires periodic flushing of the static mix tube to prevent accumulation of cured polyurea, which could plug the spray gun.

Viscosity behavior of the each of the components is particularly important for two part spray coating processes. With low pressure positive displacement mixing, the two parts should be as close as possible in viscosity to allow adequate mixing and even cure. Preferably, the viscosity of the combined composition (Components I and II) is between 500-2500 centipoise at room temperature, more preferably 800-1200 centipoise, as measured using a Brookfield LVDVI viscometer. Optionally, the viscosity may be adjusted at the time of mixing by heating one or both sides of the multiple part system prior to spray mixing.

The compositions as described above are mixed together in a suitable manner, and applied to an intended substrate at a thickness of from about 3 to about 100 mills, more preferably from about 5 to about 50 mils, most preferably from about 20 to 25 mils. Preferred ranges of thickness depend on the final article to be manufactured. The novel composition of the present invention offers the advantage of a rapid dray time so that the composition may hold up at a thicker film application than the prior art. For example, in preferred embodiments of the present invention, the 2K composition may be applied at a thickness of between 20-25 mils and may be stable until hard dry (preferably within 15 minutes).

The compositions as described above are preferably formulated to an applied coating with a tack-free time of 10 seconds to 30 minutes, more preferably 45 seconds to 15 minutes. The coating is versatile enough to be used for fast or slow systems, depending on the aspartate used, and the tack-free time can be adjusted up or down, depending on the needs of the user.

In one aspect of the present invention, the coating of the present invention is applied to a substrate for coating of that substrate as a topcoat. In this embodiment, the present invention provides a convenient laminate providing high strength without the need for conventional lamination techniques incorporating pressure and heat application. Thus, existing articles may be readily coated with a new and aesthetically pleasing coating. Examples of such articles include bathtubs, appliance surfaces, furniture such as tables and chairs, counter tops, boats, and the like.

In another aspect of the present invention, the coating of the present invention may be applied to a mold surface as a gel coat, and allowed to cure with later removal of the mold to provide the shaped article created thereby. It has been found that the coatings of the present invention provide specific benefit as gel coats, because the coatings are readily removed from the mold. While not being bound by theory, it is believed that the hardness properties of the coatings contribute to the ability to de-mold gel coats of the present invention. Optionally, after allowing the coating as applied to the mold to become tack free, subsequent materials such as structural foams, may be applied thereto to provide a more rigid structure. Alternatively, a framework made from a more rigid material, such as metal, wood, composite, fiber reinforced foam, cardboard or the like, may be fastened to the cured coating by adhesive, structural foam, mechanical fasteners, combinations of the above, and the like. The prepared gel coat product preferably has at least sufficient rigidity to be readily removed from the mold. The ability to utilize a wide variety of materials in combination with the gel coat of the present invention makes it possible to create aesthetically pleasing articles while achieving a high strength/low weight ratio. The present invention thus provides aesthetically pleasing articles in a low cost manufacturing system.

Preferably, coating compositions of the present invention are sprayed on the substrate while maintaining a volumetric ratio of from 1:10 to 10:1 for the ratio of component I to component II. More preferably, a 1:3 to 3:1 volumetric ratio is maintained. In one embodiment, a 2:1 volumetric ratio of component I to component Ills maintained.

Additional examples of suitable substrates include, but are not limited to, metal, natural and/or synthetic stone, ceramic, glass, brick, cement, concrete, cinderblock, wood and composites and laminates thereof; wallboard, drywall, sheetrock, cement board, plastic, paper, PVC, styrofoam, plastic composites, acrylic composites, saturated or unsaturated polyurethane composites, saturated or unsaturated polyester composites, asphalt, fiberglass, soil, or gravel.

### EXAMPLES

The instant process is illustrated, but in no way restricted, by the following examples in which quantities quoted represent parts by weight or percentages by weight, unless otherwise stated.

### Example 1

An amine functional polyaspartic ester having 20 wt. % acrylate was prepared by the following procedure:

921.5 g of PACM-20 (4-4′diamino dicyclohexyl methane) and 446.28 g of SR-238 (1,6-hexanediol diacrylate supplied by Sartomer USA, LLC) were charged to a round bottom flask. The mixture was mixed at 166 rpm and heated to 60° C. The reaction was allowed to proceed for 7 hours. 830.1 g of diethyl maleate were charged to the flask at a rate slow enough to keep the temperature under 60° C. (4.5 hours). The mixture was held at 60° C. for an additional 3.5 hours.

The resulting acrylate modified polyaspartic acid ester had an amine number of 219, a viscosity at 25° C. of 11,258 cps after three weeks, a viscosity shear rate per second of 40, a density of 9.2 lbs/gal, and was 100% in solids.

TABLE 1
Polyaspartic ester

| | Charge | | | |
|---|---|---|---|---|
| Material | Wt. (g) | Eq Wt | Eq | Wt. |
| PACM-20 | 921.95 | 105.09 | 8.765 | 105.19 |
| Diethyl | 830.01 | 172.18 | 4.821 | 94.70 |
| maleate | | | | |
| Sartomer ® | 446.29 | 113.15 | 3.944 | 50.92 |
| SR-238 | | | | |
| BHT | 1.75 | | | 0.2 |
| Total | 2200.00 | | | 251.01 |
| Weight | | | | |

BHT: Butylated hydroxytoluene;
PACM-20: 4-4′diamino dicyclohexyl methane

### Example 2

Coating compositions as detailed in TABLES 2-6 were prepared as follows: Component I was prepared by addition of the ingredients into a plastic pail liner, under agitation, in the order given, using a Hockmeyer model 2 L, 3 H.P. mixer with a 4 inch diameter high-lift impeller at a 1000 setting. When all the ingredients were added the speed setting was increased to between 3000 and 4000 to disperse the TiO₂ pigment. After 30 minutes, the mixture was transferred to another Hockmeyer mixer fitted with a 4 inch Cowels® type mixing blade and equipped with a means of mixing under a vacuum of “27 mm of Hg where it was mixed an additional 30 minutes at the slowest speed (to minimize splashing). The mixer was stopped and then the vacuum was curtailed. This de-aerated the mixture.

Component II in certain compositions was two polymeric isocyanates that were mixed using a high lift impeller. Care was taken to protect the mixture from exposure to moisture.

A suitable extremely smooth surface was chosen on which to apply the gel coat. This could be a commercial mold or for flat test items, 12″×17″ photographic Ferrotype plates can be used. A mold release agent was applied to the substrate. Application of the gel coat was done while avoiding entrapping air by the use of a Langeman GL-4 airless spray apparatus using the lowest atomization air pressure possible or a pneumatic applicator such as made by P.C.Cox Limited. A 2:1 by volume mixture of the component 1 to component 2 was used to provide a coating having about 20-25 mils of thickness.

Samples prepared as described above were analyzed using (1) ASTM D6695: “Standard Practice for Xenon-Arc Exposures of Paint and Related Coatings”; and (2) a modification of ASTM D6695 to add a chlorine emersion cycle. This modified test was 7 days of ASTM D6695 cycle 5 followed by 24 hours of immersion in 10 ppm chlorinated water. Each 8 day period was considered 1 cycle.

After 5000 hours of accelerated exposure in a weather-o-meter running ASTM D6695 cycle 5, the comparative gel coat (TABLE 5) retained 5% of its gloss (see FIG. 1). The three formulas of the present invention (TABLES 2, 3 and 4) retained between 81-83% of their gloss after the same period of exposure (see FIG. 1). After 16 cycles of the modified ASTM D6695, the control gel coat (TABLE 6) was at 25% gloss retention as compared to the three formulas of the present invention (TABLES 2, 3 and 4) which retained 76-84% gloss (FIG. 2). Note that Byk® 358 is Byk® 361 supplied at 52% solids in alkylbenzenes.

TABLE 2
Gel coat composition with 10 wt. % acrylate

| | | | Weight | Volume |
|---|---|---|---|---|
| Raw Material | Weight | Volume | Solids | Solids |
| Component 1 | | | | |
| Polyaspartic Ester | 107.40 | 12.05 | 107.40 | 12.05 |
| prepared | | | | |
| according to Example 1 | | | | |
| Desmophen® NH 1420 | 107.40 | 12.20 | 107.40 | 12.20 |
| BYK®-361 N | 1.37 | 0.16 | 1.34 | 0.16 |
| BYK®-A 530 | 2.95 | 0.44 | 0.15 | 0.00 |
| Silquest® A-171 Silane | 5.89 | 0.73 | 5.89 | 0.73 |
| Colormatch® DAB- | 67.93 | 6.46 | 67.93 | 6.36 |
| 30455 (Blue 29) | | | | |
| MIN-U-SIL® 15 | 68.65 | 3.10 | 68.65 | 3.10 |
| Tinuvin® 292 | 4.48 | 0.54 | 4.48 | 0.54 |
| Tinuvin® 1130 | 4.48 | 0.46 | 4.48 | 0.46 |
| Mesamoll® | 29.46 | 3.34 | 29.46 | 3.34 |
| Subtotal | 400.00 | 39.49 | 397.17 | 38.95 |
| Component 2 | | | | |
| Desmodur® XP 2795 | 189.24 | 19.73 | 189.24 | 19.73 |
| Subtotal | 189.24 | 19.73 | 189.24 | 19.73 |
| Total | 589.24 | 59.23 | 586.41 | 58.69 |

Theoretical Results

| | | | |
|---|---|---|---|
| Weight | 99.52 | Wt/Gal | 9.95 |
| Solids | | Mix Ratio (volume) | 2.00:1 |
| Volume | 99.09 | NCO:OH | 1.10 |
| Solids | | Theoretical VOC | 0.05 |
| P/B | 0.20 | | |
| PVC | 7.94 | | |

TABLE 3
Gel coat Composition with 10 wt. % acrylate and polyol

| | | | Weight | Volume |
|---|---|---|---|---|
| Raw Material | Weight | Volume | Solids | Solids |
| Component 1 | | | | |
| Polyaspartic Ester | 160.54 | 18.02 | 160.54 | 18.02 |
| prepared | | | | |
| according to Example 1 | | | | |
| Desmophen® NH 1420 | 160.54 | 18.24 | 160.54 | 18.24 |
| Desmophene® XP 2488 | 16.90 | 1.81 | 16.90 | 1.81 |
| BYK®-361 N | 2.24 | 0.26 | 2.19 | 0.25 |
| BYK®-A 530 | 4.96 | 0.74 | 0.25 | 0.01 |
| Silquest® A-171 Silane | 9.93 | 1.23 | 9.93 | 1.23 |
| Colormatch®DAB-30455 | 114.33 | 10.88 | 114.33 | 10.71 |
| (Blue 29) | | | | |
| MIN-U-SIL® 15 | 111.15 | 5.03 | 111.15 | 5.03 |
| Tinuvin® 292 | 7.31 | 0.89 | 7.31 | 0.89 |
| Tinuvin® 1130 | 7.31 | 0.75 | 7.31 | 0.75 |
| Mesamoll® | 77.44 | 8.79 | 77.44 | 8.79 |
| Subtotal | 672.66 | 66.62 | 667.90 | 65.71 |
| Component 2 | | | | |
| Desmodur® XP 2795 | 320.11 | 33.38 | 320.11 | 33.38 |
| Subtotal | 320.11 | 33.38 | 320.11 | 33.38 |
| Total | 992.77 | 100.00 | 988.01 | 99.09 |

Theoretical Results

| | | | |
|---|---|---|---|
| Weight | 99.52 | Wt/Gal | 9.93 |
| Solids | | Mix Ratio (volume) | 2.00:1 |
| Volume | 99.09 | NCO:OH | 1.10 |
| Solids | | Theoretical VOC | 0.05 |
| P/B | 0.20 | | |
| PVC | 7.96 | | |

TABLE 4
Gel coat Composition with 5 wt. % acrylate and polyol

| | | | Weight | Volume |
|---|---|---|---|---|
| Raw Material | Weight | Volume | Solids | Solids |
| Component 1 | | | | |
| Polyaspartic Ester | 48.56 | 5.45 | 48.56 | 5.45 |
| prepared | | | | |
| according to | | | | |
| Example 1 | | | | |
| Desmophen® NH | 145.67 | 16.55 | 145.67 | 16.55 |
| 1420 | | | | |
| Desmophen® XP | 10.22 | 1.09 | 10.22 | 1.09 |
| 2488 | | | | |
| BYK®-361 N | 1.34 | 0.16 | 1.32 | 0.15 |
| BYK®-A 530 | 2.95 | 0.44 | 0.15 | 0.00 |
| Silquest® A-171 | 5.90 | 0.73 | 5.90 | 0.73 |
| Silane | | | | |
| Colormatch® DAB- | 68.58 | 6.53 | 68.58 | 6.42 |
| 30455 (Blue 29) | | | | |
| MIN-U-SIL® 15 | 66.68 | 3.02 | 66.68 | 3.02 |
| Tinuvin® 292 | 4.39 | 0.53 | 4.39 | 0.53 |
| Tinuvin® 1130 | 4.39 | 0.45 | 4.39 | 0.45 |
| Mesamoll® | 41.32 | 4.69 | 41.32 | 4.69 |
| Subtotal | 400.00 | 39.63 | 397.17 | 39.09 |
| Component 2 | | | | |
| Desmodur® XP 2795 | 190.31 | 19.84 | 190.31 | 19.84 |
| Subtotal | 190.31 | 19.84 | 190.31 | 19.84 |
| Total | 992.77 | 100.00 | 988.01 | 99.09 |

Theoretical Results

| | | | |
|---|---|---|---|
| Weight | 99.52 | Wt/Gal | 9.93 |
| Solids | | Mix Ratio | 2.00:1 |
| Volume | 99.09 | (volume) | |
| Solids | | NCO:OH | 1.10 |
| P/B | 0.20 | Theoretical VOC | 0.05 |
| PVC | 7.96 | | |

The control gel coat (TABLE 5) was formulated with isophorone diamine (IPDA) to increase cure times and provide a non-sagging coating which could be applied at a comparable thickness to the three formulas of the present invention (TABLES 2, 3 and 4). IPDA was not required to produce similar behavior in any of the compositions of the present invention.

TABLE 5
Comparative gel coat composition with polyol

| | | | Weight | Volume |
|---|---|---|---|---|
| Raw Material | Weight | Volume | Solids | Solids |
| Component 1 | | | | |
| Polyaspartic Ester | 219.28 | 24.61 | 219.28 | 24.61 |
| prepared | | | | |
| according to | | | | |
| example 1 of | | | | |
| U.S. Pat. No. | | | | |
| 8,178,204 | | | | |
| Desmophen® XP | 11.33 | 1.21 | 11.33 | 1.21 |
| 2488 | | | | |
| Isophorone | 10.65 | 1.39 | 10.65 | 1.39 |
| diamine (IPDA) | | | | |
| BYK®-361 N | 3.33 | 0.42 | 1.73 | 0.2 |
| BYK®-A 530 | 6.66 | 0.99 | 0.33 | 0.01 |
| Silquest® A-171 | 8.00 | 0.99 | 8.00 | 0.99 |
| Silane | | | | |
| Novacite® L-207A | 106.65 | 4.82 | 106.65 | 4.82 |
| Mesamoll® | 63.99 | 7.26 | 63.99 | 7.26 |
| Colormatch® DAB- | 87.32 | 8.31 | 87.32 | 8.18 |
| 30455 (Blue 29) | | | | |
| Subtotal | 517.21 | 50 | 509.28 | 48.67 |
| Component 2 | | | | |
| Desmodur® N-100 | 215.81 | 22.48 | 215.18 | 22.48 |
| Desmodur® N- | 23.97 | 2.52 | 23.97 | 2.52 |
| 3900 | | | | |
| Subtotal | 239.79 | 25 | 239.78 | 25 |
| Total | 756.99 | 75 | 749.06 | 73.67 |

Theoretical Results

| | | | |
|---|---|---|---|
| Weight | 98.95 | Wt/Gal | 10.09 |
| Solids | | Mix Ratio | 2.00:1 |
| Volume | 98.23 | (volume) | |
| Solids | | NCO:OH | 1.08 |
| P/B | 0.22 | Theoretical | 0.11 |
| PVC | 5.68 | VOC | |

TABLE 6
Comparative clear coat Composition

| | | | Weight | Volume |
|---|---|---|---|---|
| Raw Material | Weight | Volume | Solids | Solids |
| Component 1 | | | | |
| Polyaspartic | 94.91 | 10.65 | 94.91 | 10.65 |
| Ester | | | | |
| prepared | | | | |
| according to | | | | |
| example 1 of | | | | |
| U.S. Pat. No. | | | | |
| 8,178,204 | | | | |
| Amyl acetate | 48.83 | 6.68 | 0 | 0 |
| Tinuvin® 292 | 1.68 | 0.2 | 1.68 | 0.2 |
| Tinuvin® 1130 | 1.68 | 0.17 | 1.68 | 0.17 |
| BYK®-361 N | 1.25 | 0.16 | 0.65 | 0.08 |
| BYK®-A 530 | 1.25 | 0.19 | 0.06 | 0 |
| Silquest® A- | 2.86 | 0.35 | 2.86 | 0.35 |
| 171 Silane | | | | |
| Subtotal | 152.46 | 18.4 | 101.84 | 11.46 |
| Component 2 | | | | |
| Desmodur® | 97.54 | 11.02 | 73.16 | 7.68 |
| N-75 BA/X | | | | |
| Subtotal | 97.54 | 11.02 | 73.16 | 7.68 |
| Total | 250 | 29.43 | 175 | 19.13 |

Theoretical Results

| | | | |
|---|---|---|---|
| Weight | 70 | Wt/Gal | 8.5 |
| Solids | | Mix Ratio | 1.67:1 |
| Volume | 65.03 | (volume) | |
| Solids | | NCO:OH | 1.10 |
| P/B | 0 | Theoretical | 2.55 |
| PVC | 0 | VOC | |

It will be appreciated that the aforementioned embodiments and implementations are illustrative and various aspects of the invention may have applicability beyond the specifically described contexts. Furthermore, it is to be understood that these embodiments and implementations are not limited to the particular components, methodologies, or protocols described, as these may vary. The terminology used in the description is for the purpose of illustrating the particular versions or embodiments only, and is not intended to limit their scope in the present disclosure which will be limited only by the appended claims.

1. A coating composition comprising:
(I) Component I comprising an acrylate modified amine functional polyaspartic acid ester having an acrylate/acid ester mixture of from greater than 2 to 30 wt. % acrylate; and
(II) Component II consisting essentially of one or more aliphatic polyisocyanates.

2. The composition of claim 1, wherein Component I further comprises a low molecular weight short chain polyol having a hydroxyl value of >100.

3. The composition of claim 1, wherein the acrylate modified amine functional polyaspartic acid ester comprises the reaction product of one or more (cyclo)aliphatic diamines, one or more diacrylate compounds and one or more maleic and/or fumaric acid esters.

4. The composition of claim 1, wherein the polyaspartic acid ester and aliphatic polyisocyanate are present in a molar ratio of from 1.0 polyaspartic acid ester:0.9 polyisocyanate to 1.0 polyaspartic acid ester:1.5 polyisocyanate.

5. The composition of claim 1, wherein the aliphatic polyisocyanate has an average functionality of at least 3 NCO groups.

6. The composition of claim 1, wherein the aliphatic polyisocyanate is a mixture of an asymmetric trimer of HDI and an HDI-based polymeric isocyanate containing biuret groups.

7. The composition of claim 3, wherein the (cyclo)aliphatic diamine is isophorone diamine or 4,4-diaminodicyclohexylmethane.

8. The composition of claim 3, wherein the diacrylate compound is 1,6-hexandiol diacrylate.

9. The composition of claim 1, wherein the composition comprises between 35-65 wt. % polyaspartic acid ester, 25-35 wt. % polyisocyanate, 2-10 wt. % plasticizer, 0.25-3.0 wt. % moisture scavenger and 0.25-3.0 wt. % deaerator.

10. The composition of claim 1, wherein the acrylate modified amine functional polyaspartic acid ester is a mixture of acrylate modified aspartates and non-acrylate modified aspartates.

11. A method of coating a substrate, the method comprising the step of mixing and applying Components I and II of a coating composition to a substrate using a spray apparatus, wherein the coating composition comprises:
(I) Component I comprising of an acrylate modified amine functional polyaspartic acid ester having an acrylate/acid ester mixture of from greater than 2 top 30 wt. % acrylate; and
(II) Component II consisting essentially of one or more aliphatic polyisocyanates.

12. The method of claim 11, wherein the coating composition is sprayed on the substrate while maintaining a volumetric ratio of from 1:10 to 10:1 for the ratio of Component I to Component II.

13. The method of claim 12, wherein a 2:1 volumetric ratio of Component I to Component II is maintained.

14. The method of claim 11, wherein the coating is applied to the substrate in a thickness of 10 to 100 mils.

15. The method of claim 11, wherein the coating is applied to the substrate in a thickness of 20 to 25 mils.

16. A substrate coated with the composition of claim 1.

17. The substrate of claim 16, wherein the substrate is comprised of metal, natural and/or synthetic stone, ceramic, glass, brick, cement, concrete, cinderblock, wood and composites and laminates thereof; wallboard, drywall, cement board, plastic, paper, PVC, styrofoam, plastic composites, acrylic composites, polyurethane composites, polyester composites, asphalt, fiberglass, soil, or gravel.

18. A polyaspartic acid ester comprising:
i) an acrylate modified polyaspartic acid ester consisting essentially of the reaction product of one or more (cyclo)aliphatic diamines, one or more diacrylates and one or more maleic and/or fumaric acid esters; and
ii) a polyaspartic acid ester consisting essentially of the reaction product of one or more (cyclo)aliphatic diamines and one or more maleic and/or fumaric acid esters.

19. The polyaspartic acid ester of claim 18, wherein the ratio of amine to amine-reactive components is from 0.95:1.0 to 1.05:1.0.

20. The polyaspartic acid ester according to claim 18, wherein the one or more (cyclo)aliphatic diamines, one or more diacrylates and one or more maleic and/or fumaric acid esters of (i) are reacted together in a ratio of from 1 equivalent diamine:0.3 equivalents diacrylate:0.7 equivalents maleic and/or fumaric acid ester, to 1 equivalent diamine:0.05 equivalents diacrylate:0.95 equivalents maleic and/or fumaric acid ester.

21. The polyaspartic acid ester according to claim 18, wherein (i) comprises the reaction product of 4-4′diamino dicyclohexyl methane, 1,6 hexanediol diacrylate and diethyl maleate.

22. The coating composition of claim 1, wherein the acrylate/acid ester mixture comprises 5-10 wt. % acrylate.

23. The method of claim 11, wherein the acrylate/acid ester mixture comprises 5-10 wt. % acrylate.

24. A coating composition comprising:
A) the polyaspartic acid ester of claim 18; and
B) one or more aliphatic polyisocyanates.

25. The coating composition of claim 24, wherein the acrylate modified polyaspartic acid ester has an acrylate/acid ester mixture of from greater than 2 up to 30 wt. % acrylate.

26. The coating composition of claim 25, wherein the acrylate/acid ester mixture comprises 5-10 wt. % acrylate.
